(19) United States
(12) Patent Application Publication
(10) Pub. No.: US 2014/0240264 A1
(43) Pub. Date: Aug. 28, 2014

(54) METHOD OF CONTROLLING EVENT AND ELECTRONIC DEVICE THEREOF

(71) Applicant: Samsung Electronics Co., Ltd., Gyeonggi-do (KR)

(72) Inventors: Yo-Ywang IM, Gyeonggi-do (KR); Mi-Hyang Kim, Gyeonggi-do (KR); Jeong-Hun Kim, Gyeonggi-do (KR); Kwang-Weon Park, Gyeonggi-do (KR)

(73) Assignee: Samsung Electronics Co., Ltd., Gyeonggi-do (KR)

(21) Appl. No.: 14/193,865

(22) Filed: Feb. 28, 2014

(30) Foreign Application Priority Data
Feb. 28, 2013 (KR) 10-2013-0021781

(51) Int. Cl. G06F 1/16; G06F 3/041

(52) U.S. Cl. CPC G06F 1/1652; G06F 3/041
USPC 345/173

(57) ABSTRACT

A flexible display is applied to a method of controlling an event and an electronic device thereof, and in the electronic device having the flexible display, a method of controlling an intuitive event according to a user's intention and an electronic device thereof are provided.

### PRIORITY

This application claims priority under 35 U.S.C. §119(a) to a Korean Patent Application Serial No. 10-2013-0021781, which was filed in the Korean Intellectual Property Office on Feb. 28, 2013, the entire disclosure of which is incorporated herein by reference.

### BACKGROUND OF THE INVENTION

1. Field of the Invention

The present invention generally relates to a method of controlling an event and an electronic device thereof.

2. Description of the Related Art

Electronic devices, such as a mobile phone, a Portable Multimedia Player (PMP), and a Personal Digital Assistant (PDA), use a display such as a Liquid Crystal Display (LCD), a Light Emitting Diode (LED) display, an Organic Light Emitting Diode (OLED) display, and an Active Matrix OLED (AMOLED), and as a substrate of a general display, a glass substrate is used. Recently, an electronic newspaper and an electronic book to which a flexible display is applied are now available. Such a flexible display is beneficial in that it may be bent or folded by applying a flexible plastic film to a substrate, and is thus used in many fields.

However, because an action of bending an electronic device having a flexible display is performed for only the simple purpose of dividing and showing contents displayed on a screen, such an action could not satisfy a user's various desires. Therefore, a method of controlling an intuitive event according to a user's intention is needed.

### SUMMARY OF THE INVENTION

An aspect of the present invention is to solve at least the above-mentioned problems and/or disadvantages and to provide at least the advantages described below. Accordingly, an aspect of the present invention is to provide an electronic device having a flexible display and a method of controlling the same.

Another aspect of the present invention is to provide a method of controlling an event in an electronic device having a flexible display, and an electronic device thereof.

Another aspect of the present invention is to provide a method of controlling an intuitive event according to a user's intention in an electronic device having a flexible display, and an electronic device thereof.

In accordance with an aspect of the present invention, a method of controlling an electronic device includes detecting a touch of at least one portion other than a flexible display of the electronic device; detecting deformation of the electronic device in a state in which the touch is maintained; detecting a motion of the electronic device within a predetermined time; and causing an event to occur according to the motion.

In accordance with another aspect of the present invention, an electronic device includes a flexible display; a grip sensor that detects a touch of at least one portion other than the flexible display; a deformation detection sensor that detects deformation of the electronic device in a state in which the touch is maintained; a motion sensor that detects a motion of the electronic device within a predetermined time; and a processor that causes an event to occur according to the motion.

In accordance with another aspect of the present invention, a method of controlling an electronic device includes: detecting a touch of at least one portion other than a flexible display of the electronic device; detecting deformation and a motion of the electronic device within a predetermined time in a state in which the touch is maintained; and causing an event to occur according to the deformation and motion.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a diagram illustrating bending of an electronic device according to an embodiment of the present invention;

FIG. 2A is a block diagram illustrating a configuration of an electronic device according to an embodiment of the present invention;

FIG. 2B is a block diagram illustrating a configuration of a sensor device according to an embodiment of the present invention;

FIG. 3 is a flowchart illustrating a method of controlling an event according to an embodiment of the present invention;

FIG. 4 is a flowchart illustrating a method of controlling an event according to an embodiment of the present invention;

FIG. 5 is a flowchart illustrating a method of controlling an event according to another embodiment of the present invention;

FIG. 6 is a flowchart illustrating a method of controlling an event according to another embodiment of the present invention;

FIG. 7A is a top plan view illustrating an electronic device according to an embodiment of the present invention;

FIG. 7B is a perspective view illustrating an electronic device according to an embodiment of the present invention;

FIGS. 8A to 8C are diagrams illustrating a method of controlling an event according to an embodiment of the present invention; and

FIGS. 9A and 9B are diagrams illustrating a method of controlling an event according to another embodiment of the present invention.

### DETAILED DESCRIPTION OF EMBODIMENTS OF THE PRESENT INVENTION

While the present invention may be embodied in many different forms, specific embodiments of the present invention are shown in drawings and are described herein in detail, with the understanding that the present disclosure is to be considered as an exemplification of the principles of the invention and is not intended to limit the invention to the specific embodiments illustrated.

Terms such as “first” and “second” are used for describing various constituent elements, but the constituent elements are not limited by the terms. The terms are used only for distinguishing a constituent element from other constituent elements. For example, while not deviating from the scope of the present invention, a second constituent element may be referred to as a first constituent element and similarly, a first constituent element may be referred to as a second constituent element

Throughout this specification and the claims that follow, when it is described that an element is “connected” or “coupled” to another element, it should be understood that the element may be directly connected or coupled to the other element or electrically coupled to the other element through a third element. In contrast, when it is described that an element is “directly connected” or “directly coupled” to another element, it should be understood that there is no intermediate part between the two parts.

Technical terms used here are to only describe a specific embodiment and are not intended to limit the present invention. Singular forms used here include a plurality of forms unless phrases explicitly represent an opposite meaning. A meaning of “comprising” used in a specification embodies a specific characteristic, numeral, step, operation, element, component, or combinations thereof and does not exclude presence or addition of anther characteristic, numeral, step, operation, element, component, or combinations thereof.

Embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the terms may vary depending on user's or operator's intention and usage. That is, the terms used herein must be understood based on the descriptions made herein.

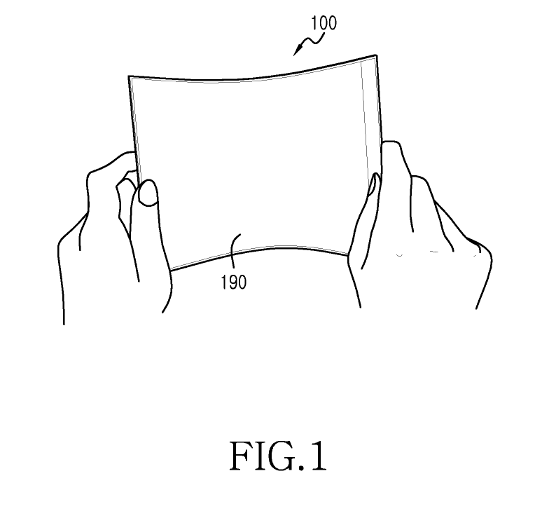

FIG. 1 is a diagram illustrating bending of an electronic device according to an embodiment of the present invention.

Referring to FIG. 1, an electronic device 100 may be a device such as a mobile phone, a mobile pad, a media player, a tablet computer, a hand-held computer, a Personal Digital Assistant (PDA), and the like. Further, the electronic device 100 may be a random electronic device including a device to which two or more functions are coupled among such devices.

As the electronic device 100 has a flexible display 190, the electronic device is formed to be flexible and foldable. As shown in FIG. 1, the electronic device 100 is provided with the flexible display 190 and may be used in a state folded inwardly. Further, for example, the flexible display 190 may be a double-sided display that utilizes both surfaces and the electronic device 100 is foldable in an opposite direction.

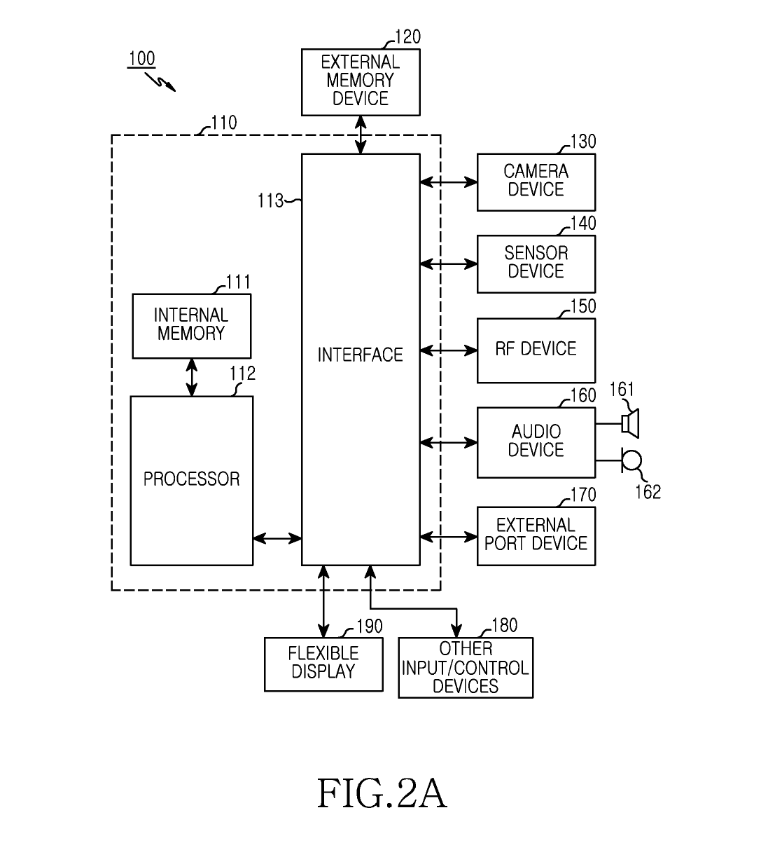

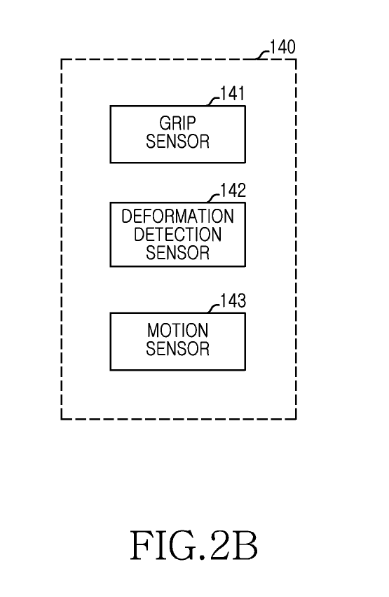

FIG. 2A is a block diagram illustrating a configuration of an electronic device according to an embodiment of the present invention, and FIG. 2b is a block diagram illustrating a configuration of a sensor device according to an embodiment of the present invention.

Referring to FIGS. 2A and 2B, the electronic device 100 includes a host device 110, an external memory device 120, a camera device 130, a sensor device 140, a radio frequency (RF) device 150, an audio device 160, an external port device 170, a flexible display 190, and other input/control devices 180. The external memory device 120 and the external port device 170 may be formed by plural devices.

The host device 110 includes an internal memory 111 and at least one processor 112 and interface 113. The internal memory 111 and the at least one processor 112 and interface 113 may be separate constituent elements or may be formed in at least one integrated circuit.

The processor 112 performs several functions for the electronic device 100 by executing several software programs and performs a processing and control for audio dedicated communication, audiovisual communication, and data communication. Further, in addition to such a common function, by executing a software program (instruction set) stored in the internal memory 111 and/or the external memory device 120, the processor 112 performs several functions corresponding to the program. That is, by interworking with software programs stored in the internal memory 111 and/or the external memory device 120, the processor 112 performs a method according to an embodiment of the present invention.

Particularly, the processor 112 may control an event according to deformation and/or a motion of the electronic device 100. A method according to an embodiment of the present invention will be described in detail hereinafter.

Further, the processor 112 may include at least one data processor, image processor, or Coder and Decoder (CODEC). Further, the electronic device 100 may separately form a data processor, an image processor, or a CODEC.

The interface 113 connects the host device 110 and several devices of the electronic device 100.

The camera device 130 may perform a camera function such as picture and video clip recording. The camera device 130 may include a Charged Coupled Device (CCD) or a Complementary Metal-Oxide Semiconductor (CMOS). Further, the camera device 130 may adjust a change of a hardware configuration, for example, lens movement and the number of an iris according to a camera program in which the processor 112 executes.

Referring to FIG. 2B, the sensor device 140 includes a grip sensor 141 that detects at least one touch, a deformation detection sensor 142 that detects deformation of the electronic device 100, and a motion sensor 143 that detects a motion of the electronic device 100.

At least one grip sensor 141 is attached to a circumferential edge or a rear surface of the electronic device 100. The grip sensor 141 may include, for example, a resistive touch sensor, a C-type capacitive touch sensor, and a strain gauge sensor.

Here, the resistive touch sensor is defined as a sensor that recognizes a coordinate according to a change of a resistance value occurring by a user's input and that detects a change of a pressure. The C-type capacitive touch sensor is defined as a sensor that determines a coordinate through a capacitance change occurring by a user's input. Further, the strain gauge sensor is defined as a sensor that recognizes a sensor internal value changed by a pressing pressure of the user and that detects a change of a pressure.

According to another implementation, a grip state may be recognized using a proximity sensor instead of the grip sensor 141. For example, when an object is detected while oscillating a high frequency of a stationary wave in an oscillation circuit, the proximity sensor detects the object according to a principle in which an oscillation amplitude of the oscillation circuit is attenuated or stopped. That is, when the user holds the electronic device 100 in his/her hand, the proximity sensor detects proximity of an object (i.e., the user's hand) and outputs a signal corresponding thereto.

The deformation detection sensor 142 includes, for example, a tension sensor, a piezoelectric element, and a terrestrial magnetic sensor. Here, the tension sensor measures tension applied to the electronic device 100. For example, when the electronic device 100 is bent, the largest tension occurs in a folding portion, and the tension sensor detects such a tension change and outputs a signal corresponding thereto. The piezoelectric element uses a principle in which a voltage occurs when a mechanical stress is applied. For example, when the electronic device 100 is bent, the largest stress occurs in a folded portion, and the piezoelectric element detects such a stress change. Further, the terrestrial magnetic sensor detects a magnetic field of the Earth and measures intensity and a vibration cycle of a magnetic field occurring in the electronic device 100, thereby knowing a form (e.g., upright and lying down) of the electronic device 100.

The motion sensor 143 includes, for example, an acceleration sensor, a gyro sensor, and a terrestrial magnetic sensor. For example, the acceleration sensor detects a dynamic force such as acceleration, a vibration, and an impact and uses an application principle of an inertial force, electric deformation, and a gyro. Alternatively, the acceleration sensor may detect a motion by measuring a cycle of an amplitude (displacement) of the electronic device 100.

As an object in which the gyro is mounted performs a rotation motion, when precession occurs, in the gyro, rotation repelling power occurs, and by measuring the force, the gyro sensor generates an electric signal proportional to a value thereof. Further, the terrestrial magnetic sensor uses a principle that searches for a slope and a direction of the electronic device 100 by detecting a magnetic field of the Earth, as described above.

The motion sensor 143 may be variously embodied with at least one combination of the acceleration sensor, the gyro sensor, and the terrestrial magnetic sensor. For example, when the electronic device 100 moves, the acceleration sensor detects motion acceleration or a vibration change of the electronic device 100. Further, when the acceleration sensor does not measure, the gyro sensor may measure, for example, an angle (azimuth) rotating relative to a surface vertical to a ground surface. The acceleration sensor includes a two-axis acceleration sensor or a three-axis acceleration sensor, and the gyro sensor includes a sensor using a principle of a two-axis or three-axis gyroscope.

The RF device 150 enables the electronic device 100 to perform wireless communication and may include an RF transmitter/receiver and a light (e g, infrared rays) transmitter/receiver. The RF device 150 may be designed to operate through one of a Global System for Mobile Communication (GSM) network, an Enhanced Data GSM Environment (EDGE) network, a Code Division Multiple Access (CDMA) network, a W-Code Division Multiple Access (W-CDMA) network, a Long Term Evolution (LTE) network, an Orthogonal Frequency Division Multiple Access (OFDMA) network, a Wireless Fidelity (Wi-Fi) network, an WiMax network or/and a Bluetooth network according to a communication network.

The audio device 160 is connected to a speaker 161 and a microphone 162 to perform an audio input and output such as voice recognition, voice duplication, digital recording, and communication functions. That is, the audio device 160 enables communication between users through the speaker 161 and the microphone 162. Further, the audio device 160 receives a data signal from the host device 110, converts the received data signal to an electric signal, and outputs the converted electric signal through the speaker 161.

The speaker 161 converts and outputs an electric signal to an audible frequency band, is disposed at the rear side of the electronic device 100, and includes a flexible film speaker in which at least one piezoelectric body is attached to one vibration film.

The microphone 162 converts a sound wave transferred from a person or other sound sources to an electric signal. Further, the audio device 160 receives an electric signal from the microphone 162, converts the received electric signal to an audio data signal, and transmits the converted audio data signal to the host device 110. The audio device 160 may include an earphone, a headphone, and a head set that may be attached to the electronic device 100 and that may be detached from the electronic device 100.

The external port device 170 directly connects the electronic device 100 to another electronic device or is indirectly connected to another electronic device through a network (e.g., Internet, intranet, or a wireless local area network (LAN)). Such an external port device 170 includes a terminal portion disposed at the rear side of the electronic device 100.

The flexible display 190 displays a signal received from the host device 110 as an image such as a text, graphic, and video. The flexible display 190 deformable in at least one deformation state such as extension, reduction, flexure, folding, twisting, bending, and spreading. Due to this reason, the electronic device 100 having the flexible display 190 may be folded and carried. Further, such a flexible display 190 includes a double-sided display that may utilize both surfaces and may apply touch screen technology to the flexible display 190.

The other input/control devices 180 include an up/down button for controlling a volume. In addition, the other input/control devices 180 may include at least one of pointer devices such as a push button, a locker button, a locker switch, a thumb-wheel, a dial, a stick, and a stylus in which a corresponding function is given.

The external memory device 120 may include a non-volatile memory and/or a high speed random access memory (RAM) such as at least one magnetic disk storage device, at least one light storage device and/or a flash memory (e.g., NAND, NOR). The external memory device 120 stores software, and the software may include an operation system program, a communication program, a graphic program, a user interface program, a codec program, and at least one application program. A term “program” may be expressed with a set of instructions, an instruction set, or a module.

The operation system program indicates an internal operation system such as WINDOWS, LINUX, Darwin, RTXC, UNIX, OS X, or VxWorks and may include various software elements for controlling a general system operation. A control of such a general system operation may include memory management and control, storage hardware (device) control and management, and power control and management. In addition, the operation system program may perform a function of smoothly performing communication between several hardware (device) and software elements (program).

The communication program may communicate with another electronic device such as a computer, a server, and an electronic device through the RF device 150 or the external port device 170.

The graphic program may include several software elements for providing and displaying graphic to the flexible display 190. A term “graphics” indicates a text, a web page, an icon, a digital image, a video, and animation.

The user interface program may include several software elements related to a user interface. Further, the user interface program may include contents on a change of a state of a user interface and contents on a condition in which a user interface state is changed.

The codec program may include a software element related to encoding and decoding of a video file.

The camera program may include a camera related software element that enables the electronic device 100 to perform camera related process and functions.

The application program may include a browser, an email, an instant message, a word processing, keyboard emulation, an address book, a touch list, a widget, digital right management (DRM), voice recognition, voice duplication, a location determining function, and a location-based service.

The host device 110 may further include additional program (instructions) in addition to the above-described programs. Further, various functions of the electronic device 100 according to an embodiment of the present invention may include hardware and/or software including at least one stream processing and/or application specific integrated circuit (ASIC).

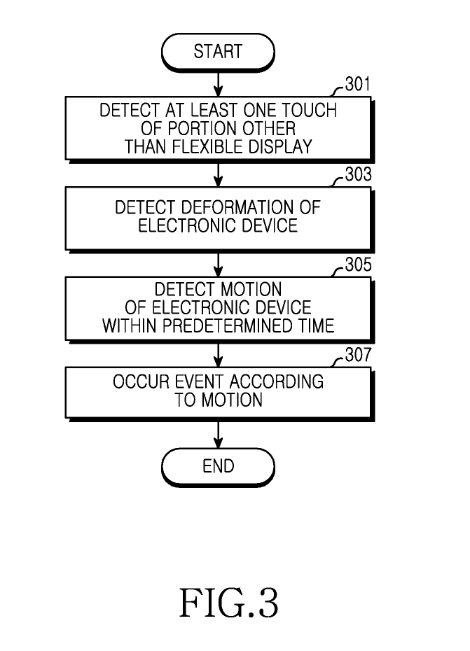

FIG. 3 is a flowchart illustrating a method of controlling an event according to an embodiment of the present invention.

Referring to FIG. 3, in step 301 the grip sensor 141 detects at least one touch of a portion other than the flexible display 190. Here, the flexible display 190 is a display in which at least one deformation such as extension, reduction, flexure, folding, twisting, bending, and spreading can be performed. Further, such a flexible display 190 includes a double-sided display that can utilize both surfaces, and touch screen technology may be applied to the flexible display 190.

A portion other than the flexible display 190 may be a portion in the electronic device 100 that includes a circumferential edge of the electronic device 100 or a rear surface of the electronic device 100. For example, at a suitable location of a circumferential edge of the electronic device 100, at least one grip sensor 141 that can detect a touch may be formed. The grip sensor 141 includes, for example, a resistive touch sensor, a C-type capacitive touch sensor, and a strain gauge sensor.

Here, the resistive touch sensor is a sensor that detects a change of a pressure by recognizing a coordinate of a change of a resistance value occurring due to a user's input. The C-type capacitive touch sensor is a sensor that determines a coordinate through a capacitance change occurring due to a user's input. Further, the strain gauge sensor is a sensor that detects a change of a pressure by recognizing a sensor internal value changed by a pressing pressure of a user.

According to another implementation, a grip state may be recognized using a proximity sensor instead of the grip sensor 141. For example, when an object is detected while oscillating a high frequency of a stationary wave in an oscillation circuit, the proximity sensor detects the object according to a principle in which an oscillation amplitude of the oscillation circuit is attenuated or stopped. That is, when the user holds the electronic device 100 in his/her hand, the proximity sensor detects proximity of an object (i.e., the user's hand) and outputs a signal corresponding thereto.

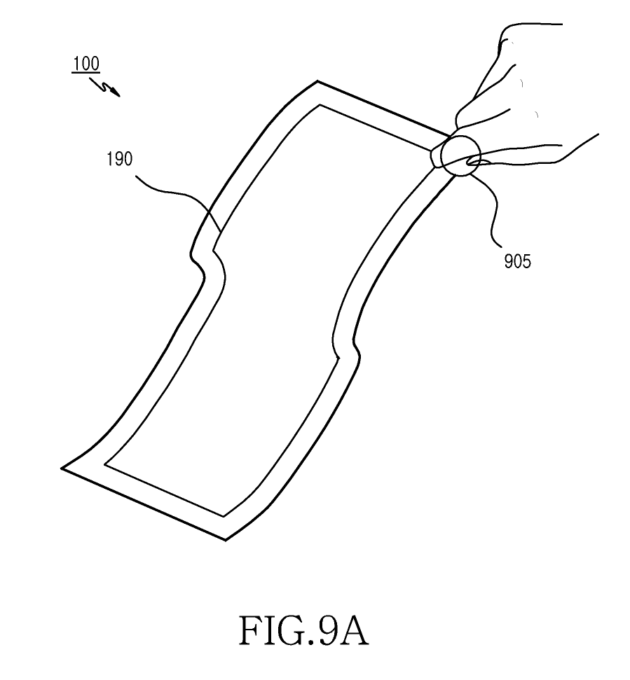

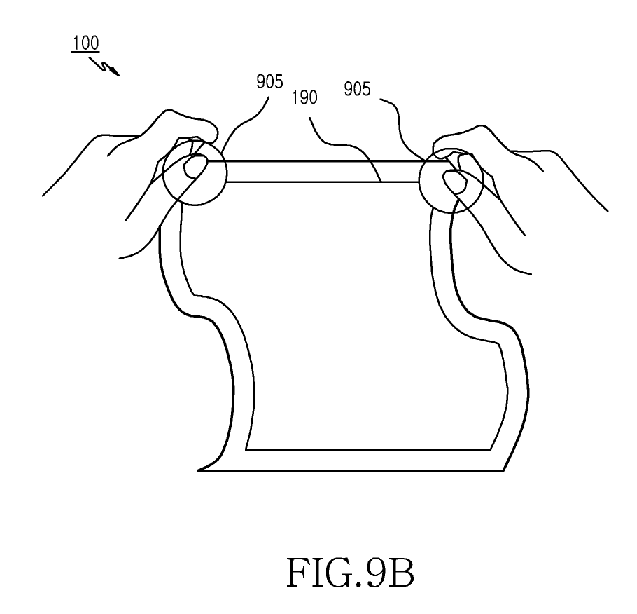

In a state in which a touch is maintained, the deformation detection sensor 142 detects deformation of the electronic device 100 in step 303. For example, as shown in FIG. 9A, when the user holds the electronic device 100, the user may deform the electronic device 100. Such deformation includes at least one of extension, flexure, folding, twisting, bending, and spreading.

The deformation detection sensor 142 includes, for example, a tension sensor, a piezoelectric element, and a terrestrial magnetic sensor. Here, the tension sensor measures tension applied to the electronic device 100. For example, when the electronic device 100 is bent, the largest tension occurs in a folded portion, and the tension sensor detects such a tension change and outputs a signal corresponding thereto. The piezoelectric element uses a principle in which a voltage occurs when a mechanical stress is applied. For example, when the electronic device 100 is bent, the largest stress occurs in the folded portion, and the piezoelectric element detects such a stress change. Further, the terrestrial magnetic sensor detects a magnetic field of the Earth and measures intensity and a vibration cycle of a magnetic field occurring in the electronic device 100, thereby knowing a form (e.g., upright and lying down) of the electronic device 100.

Thereafter, the motion sensor 143 detects a motion of the electronic device 100 within a predetermined time in step 305. Here, the predetermined time may be, for example, two seconds. A motion of the electronic device 100 includes a rotation, acceleration, and a vibration change of the electronic device 100. The motion sensor 143 includes, for example, an acceleration sensor, a gyro sensor, and a terrestrial magnetic sensor, and the motion sensor 143 may be variously embodied with at least one combination of such sensors. The acceleration sensor detects a dynamic force such as acceleration, a vibration, and an impact and may use an application principle of an inertial force, electric deformation, and a gyro. As an object in which the gyro is mounted performs a rotation motion, when precession occurs, in the gyro, rotation repelling power occurs, and by measuring the force, the gyro sensor generates an electric signal proportional to a value thereof. Further, the terrestrial magnetic sensor uses a principle that searches for a direction by detecting a magnetic field of the Earth, as described above.

The motion sensor 143 may be variously embodied with a combination of the above-described sensors, and for example, when the electronic device 100 moves, the acceleration sensor measures an acceleration change and a vibration change of the electronic device 100. Further, when the acceleration sensor does not measure, the gyro sensor may measure, for example, an angle (azimuth) rotating relative to a surface vertical to a ground surface. The acceleration sensor includes a two-axis acceleration sensor or a three-axis acceleration sensor, and the gyro sensor includes a sensor using a principle of a two-axis or three-axis gyroscope.

Thereafter, the processor 112 controls an event occurring according to a motion of the electronic device 100 in step 307. For example, according to an implementation, the processor 112 may cause an event to occur according to a motion of the electronic device 100. The processor 112 controls the electronic device 100 to perform an event previously stored at the internal memory 111 and/or the external memory device 120. The above-described event may be, for example, sound volume adjustment, screen brightness adjustment, file transmission, and unnecessary application deletion.

Further, an instruction set of such each step may be stored in at least one module at the memory. In this case, a module stored in the memory may be executed by at least one processor 112.

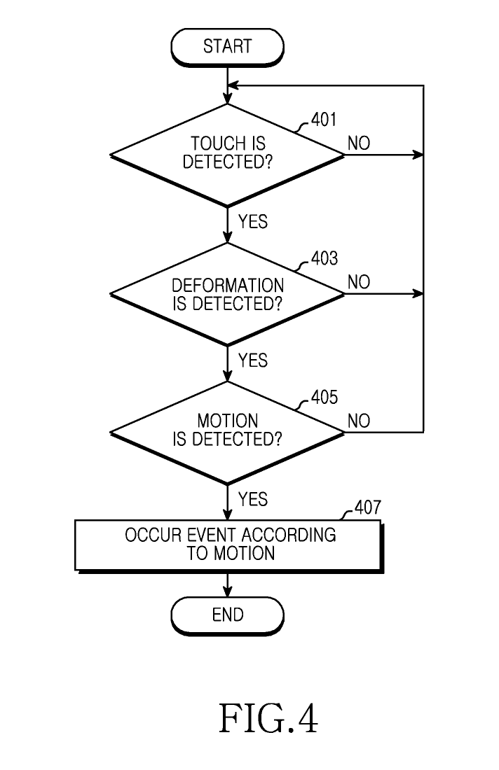

FIG. 4 is a flowchart illustrating a method of controlling an event according to an embodiment of the present invention.

Referring to FIG. 4, in step 401 the grip sensor 141 determines whether a touch of the electronic device 100 is detected. At least one grip sensor 141 may be attached to a circumferential edge or a rear surface of the electronic device 100.

If a touch of the electronic device 100 is detected at step 401, the deformation detection sensor 142 determines whether deformation of the electronic device 100 is detected in step 403.

If deformation of the electronic device 100 is detected at step 403, the motion sensor 143 detects a motion of the electronic device 100 in step 405.

The motion sensor 143 determines whether a motion of the electronic device 100 is detected in step 405, and if a motion of the electronic device 100 is detected, the processor 112 controls an event occurring according to a motion in step 407. For example, according to an implementation, the processor 112 may set an event to occur according to a motion of the electronic device 100. Alternatively, the processor 112 may control the electronic device 100 to perform an event previously stored at the internal memory 111 and/or the external memory device 120. The above-described event may be, for example, sound volume adjustment, screen brightness adjustment, file transmission, and unnecessary application deletion.

In describing the following embodiment, the following description has many portions similar to the foregoing description and therefore a detailed description thereof will be omitted.

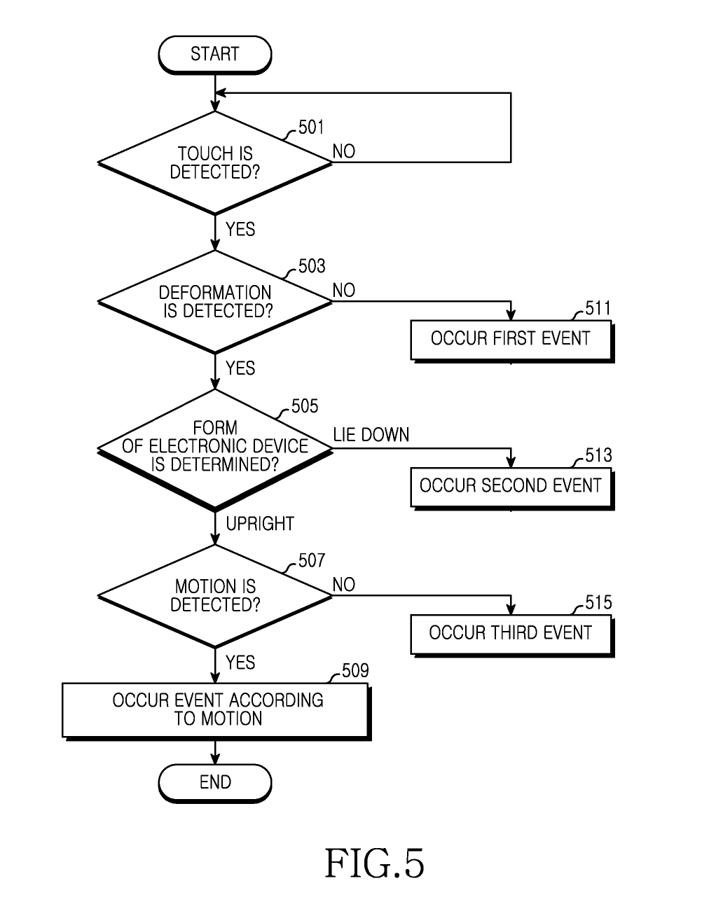

FIG. 5 is a flowchart illustrating a method of controlling an event according to another embodiment of the present invention.

Referring to FIG. 5, in step 501, the grip sensor 141 determines whether a touch of the electronic device 100 is detected.

If a touch of the electronic device 100 is detected at step 501, the deformation detection sensor 142 determines whether deformation of the electronic device 100 is detected in step 503.

If deformation of the electronic device 100 is not detected, the processor 112 controls a first event to occur in step 511. For example, the processor 112 controls to execute an event previously set to the memory. Such a first event may be, for example, screen division and sound volume adjustment.

If deformation of the electronic device 100 is detected at step 503, the deformation detection sensor 142 determines a form of the electronic device 100 in step 505. For example, the deformation detection sensor 142 may be a terrestrial magnetic sensor which detects a magnetic field of the Earth and measures a magnetic field occurring in the electronic device 100. That is, by detecting a direction of a magnetic field occurring in the electronic device 100, the terrestrial magnetic sensor determines whether the electronic device 100 is upright or is lying down.

If the electronic device 100 is lying down, the processor 112 controls a second event to occur in step 513. For example, the processor 112 controls to execute an event previously set in the memory. Such a second event may be, for example, turn-off of the electronic device 100 and change to a vibration mode.

If the electronic device 100 is upright in step 505, the motion sensor 143 determines whether a motion of the electronic device 100 is detected in step 507. If a motion of the electronic device 100 is not detected, the processor 112 controls a third event to occur in step 515. The processor 112 controls to execute an event previously set to the memory. Such a third event may be, for example, communication connection and screen brightness adjustment.

If a motion of the electronic device 100 is detected at step 507, the processor 112 controls an event to occur according to the motion in step 509. The processor 112 controls to execute an event previously set to the memory. For example, an event occurring according to a motion may be variously embodied and may be separately set by the user. Such an event may be, for example, file transmission and unnecessary application deletion.

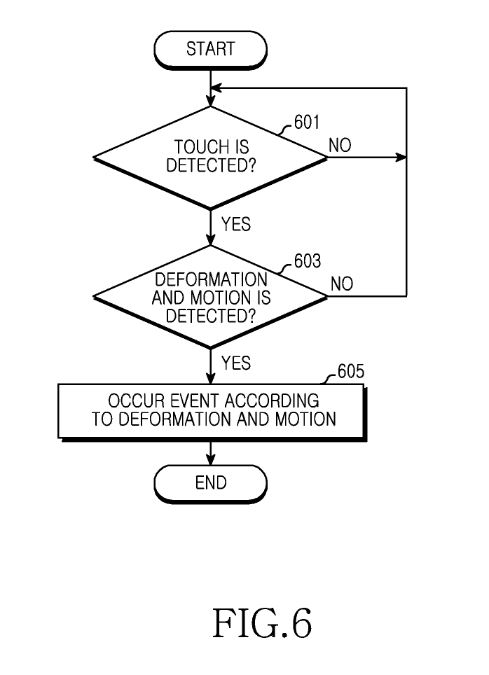

FIG. 6 is a flowchart illustrating a method of controlling an event according to another embodiment of the present invention.

Referring to FIG. 6, in step 601, the grip sensor 141 determines whether a touch of the electronic device 100 is detected.

If a touch of the electronic device 100 is detected at step 601, the deformation detection sensor 142 and the motion sensor 143 determine whether deformation and a motion of the electronic device 100 is detected in step 603. For example, the deformation detection sensor 142 and the motion sensor 143 may be simultaneously operated, or may be embodied in at least one combination of the above-described sensors. For example, as shown in FIG. 9A, when an action of holding and shaking the electronic device 100 is performed, the electronic device 100 is simultaneously deformed while a motion occurs. In such a case, deformation and a motion of the electronic device 100 are detected by the deformation detection sensor 142 and the motion sensor 143.

If deformation and a motion of the electronic device 100 are detected at step 603, the processor 112 controls an event to occur according to deformation and a motion in step 605. The processor 112 controls to execute an event previously set in the memory. For example, an event may be variously executed according to deformation and a motion of the electronic device 100 and may be separately set by the user. Such an event may be the above-described events.

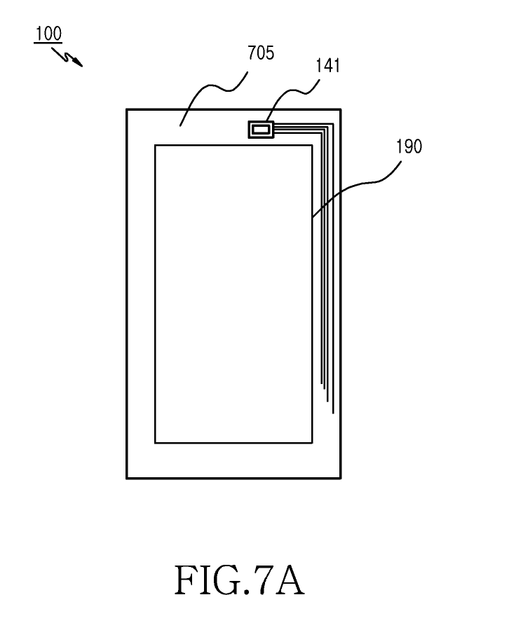

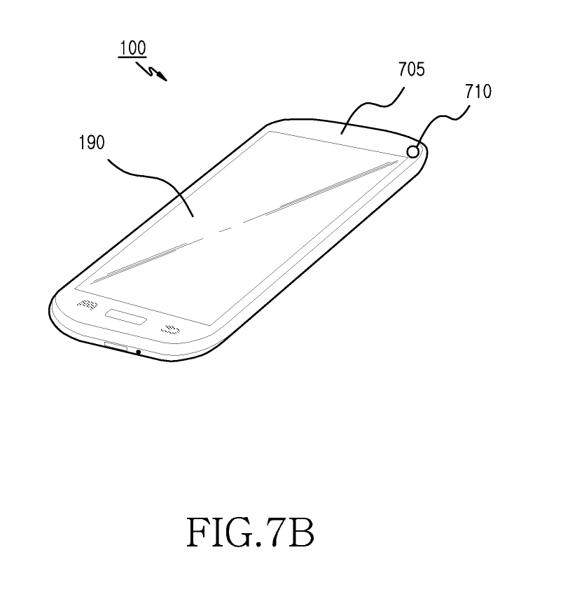

FIG. 7A is a top plan view, and FIG. 7B is a perspective view illustrating an electronic device according to an embodiment of the present invention. FIGS. 7A and 7B illustrate an attaching position of a grip sensor.

Referring to FIGS. 7A and 7B, the grip sensor 141 may be attached to, for example, at least one of a circumferential edge 705 of the electronic device 100 and a rear surface of the electronic device 100. Here, the circumferential edge 705 defines a space other than the flexible display 190 in the electronic device 100. Further, as shown in FIG. 7B, the grip sensor 141 may be preferably attached to a suitable location 710 of an upper end portion of the right side of the circumferential edge 705 of the electronic device 100. When the user holds the electronic device 100, it is preferable that such a grip sensor 141 is attached to a position in which a user's hand can easily touch.

Further, as described above, the grip sensor 141 may be embodied with one of a resistive touch sensor, a C-type capacitive touch sensor, and a strain gauge sensor. Further, the grip sensor 141, the deformation detection sensor 142, and the motion sensor 143 may be embodied regardless of any particular order.

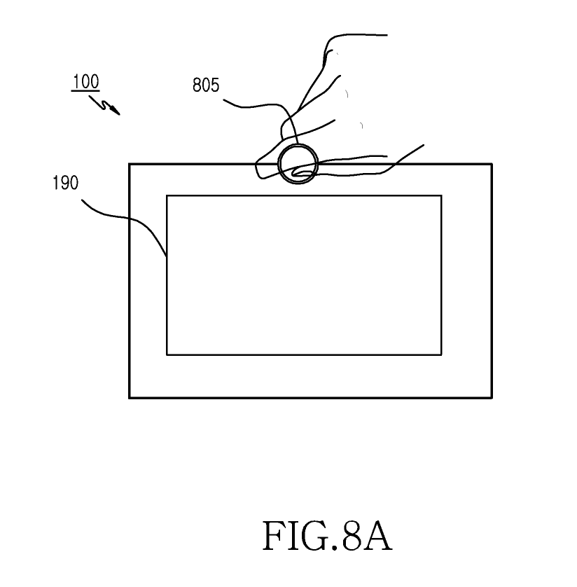

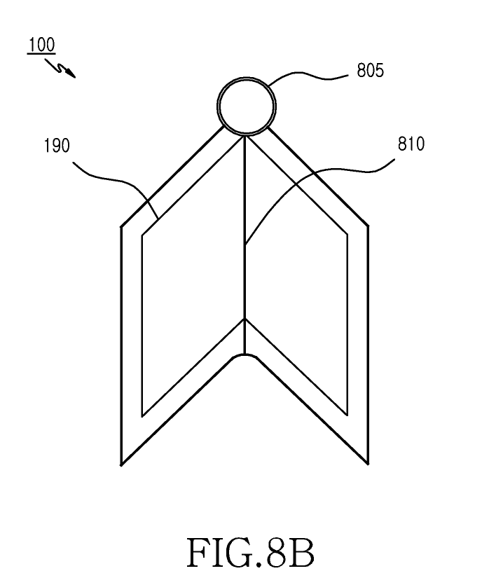

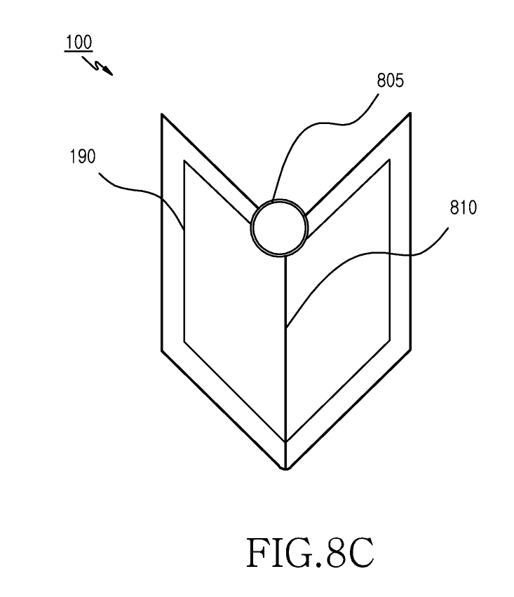

FIGS. 8A to 8C are diagrams illustrating a method of controlling an event according to an embodiment of the present invention.

Referring to FIGS. 8A to 8C, the electronic device 100 includes at least one holding portion 805. Here, the holding portion 805 is a portion in which a user holds the electronic device 100, for example, in order to execute the present invention. The grip sensor 141 is attached to the holding portion 805. As shown in FIG. 8A, when the holding portion 805 is positioned at the center of an upper portion of the electronic device 100, the grip sensor 141 detects a touch at that location.

After the grip sensor 141 detects a touch, the deformation detection sensor 142 may detect deformation of the electronic device 100. Such a deformation detection sensor 142 may be the tension sensor, the piezoelectric element, and the terrestrial magnetic sensor. When deformation of the electronic device 100 is to be detected with a piezoelectric element, a number of piezoelectric elements may be formed along the edge of the electronic device 100. As shown in FIG. 8B, when folding the electronic device 100 at the center of the electronic device 100, a bending portion 810 is formed, and a stress occurs in the bending portion 810. Thus, the piezoelectric element measures a stress applied to the bending portion 810. Further, by measuring a direction of a magnetic field occurring in the electronic device 100, the terrestrial magnetic sensor may determine a form of the electronic device 100, i.e., whether the electronic device 100 is upright or lying down.

After the deformation detection sensor 142 detects deformation of the electronic device 100, the motion sensor 143 may detect a motion of the electronic device 100 within a predetermined time, for example, two seconds. Further, a motion of the electronic device 100 includes a rotation, acceleration, and a vibration change of the electronic device 100. For example, as shown in FIG. 8C, when the electronic device 100 is rotated, a motion may be measured with the acceleration sensor and the gyro sensor. For example, the acceleration sensor senses an amplitude (displacement) of the electronic device 100, and when a cycle of the amplitude is short, acceleration increases and thus the acceleration sensor detects a motion according to a principle that receives a large impact. Further, when the acceleration sensor does not measure, the gyro sensor may measure, for example, an angle (azimuth) that rotates relative to a surface vertical to a ground surface. According to an implementation, the motion sensor 143 may be embodied with a combination of the acceleration sensor and the gyro sensor.

Thereafter, after the motion sensor 143 detects a motion of the electronic device 100, the processor 112 controls an event to occur according to a motion. For example, as shown in FIGS. 8A to 8C, while holding the holding portion 805, when rotating the electronic device 100 or when shaking the electronic device 100, an event such as sound volume adjustment, screen brightness adjustment, file transmission, and unnecessary application deletion occurs.

FIGS. 9A and 9B are diagrams illustrating a method of controlling an event according to another embodiment of the present invention.

FIG. 9A is a diagram illustrating an action of holding and shaking a portion of a corner of the electronic device 100, and FIG. 9B is a diagram illustrating an action of holding and shaking two portions of corners of the electronic device 100.

Referring to FIGS. 9A and 9B, at at least one corner of the electronic device 100, at least one holding portion 905 is formed. For example, the electronic device 100 of FIG. 9A includes a holding portion 905 of one location of an upper end portion of the right side, and FIG. 9B includes holding portions 905 at two locations of both side corners of an upper end portion. As described above, the grip sensors 141 are attached to the holding portions 905, respectively, and detect at least one touch. Further, as shown in FIG. 9B, the grip sensor 141 attached to the holding portions 905 of the two locations may simultaneously detect respective touches.

Thereafter, the deformation detection sensor 142 and the motion sensor 143 detect deformation and a motion of the electronic device 100. For example, as shown in FIGS. 9A and 9B, when performing an action of holding and shaking the electronic device 100, the electronic device 100 may be bent with a constant curvature. In such a case, for example, a piezoelectric element attached to the electronic device 100 detects a stress occurring with a curvature and outputs the detected stress value as an electrical signal. Further, the gyro sensor may measure an angle (azimuth) rotating relative to, for example, a surface vertical to a ground surface in the electronic device 100, and when flexure occurs, the acceleration sensor may measure an amplitude occurring in the electronic device 100. The deformation detection sensor 142 and the motion sensor 143 may be variously embodied with a combination of such sensors.

Thereafter, the processor 112 controls an event to occur according to the deformation and motion of the electronic device 100. For example, as shown in FIG. 9A, when holding and shaking only one side of the holding portion 905, and as shown in FIG. 9B, when holding and moving the holding portions 905 of two locations, an occurring event may be different. Such an event may be sound volume adjustment, screen brightness adjustment, file transmission, and unnecessary application deletion and the event is stored at the memory and may be set by the user.

Methods according to the embodiments described in claims and/or the above specification of the present invention can be implemented in a form of hardware components, software components, or combinations thereof.

When implemented by hardware components, a computer readable storage medium that stores at least one program (software module) may be provided. At least one program stored at a computer readable storage medium is formed to be executed by at least one processor within the electronic device. At least one program includes an instruction that enables the electronic device to execute methods according to embodiments described in claims and/or the specification of the present invention.

Such a program (software module, software) may be stored in a non-volatile memory including a random access memory (RAM) and a flash memory, a read-only memory (ROM), an electrically erasable and programmable read only memory (EEPROM), a magnetic disk storage device, a compact disk ROM (CD-ROM), a digital versatile disk (DVD), or an optical storage device of other form, and a magnetic cassette. Alternatively, the program may be stored at a memory formed with a combination of a portion or the entire thereof. Further, each constituent memory may be included in plural.

The program may be stored in an attachable storage device that may access to the electronic device through a communication network such as Internet, intranet, a local area network (LAN), a wireless LAN (WLAN), or a storage area network (SAN), or a communication network formed with a combination thereof. Such a storage device can access the electronic device through an external port.

Further, a separate electronic device on the communication network may access the portable electronic device.

While the present invention has been particularly shown and described with reference to certain embodiments thereof, it will be understood by those skilled in the art that various changes in form and details may be made therein without departing from the spirit and scope of the present invention as defined by the appended claims.

What is claimed is:

1. A method in an electronic device, the method comprising:
detecting a touch of at least one portion other than a flexible display of the electronic device;
detecting deformation of the electronic device in a state in which the touch is maintained;
detecting a motion of the electronic device within a predetermined time; and
causing an event to occur according to the motion.

2. The method of claim 1, wherein the at least one portion other than the flexible display comprises at least one of a circumferential edge and a rear surface of the electronic device.

3. The method of claim 2, wherein the circumferential edge is formed with at least one grip sensor at a suitable location.

4. The method of claim 3, wherein the grip sensor outputs a pressure change of the touch into an electrical signal.

5. The method of claim 1, wherein the deformation comprises at least one of twisting, bending, and flexure of the electronic device.

6. The method of claim 5, wherein detecting the deformation comprises detecting and outputting an electrical signal corresponding to a bending portion of the electronic device by at least one deformation detection sensor.

7. The method of claim 6, wherein the deformation detection sensor comprises at least one of a tension sensor, a piezoelectric element, and a terrestrial magnetic sensor.

8. The method of claim 1, wherein detecting the motion of the electronic device comprises detecting the motion with a motion sensor comprising at least two sensors.

9. The method of claim 8, wherein the motion sensor is one of an acceleration sensor, a gyro sensor, and a terrestrial magnetic sensor.

10. The method of claim 1, wherein the event comprises at least one of sound volume adjustment, screen brightness adjustment, file transmission, and file deletion.

11. An electronic device, comprising:
a flexible display;
a grip sensor that detects a touch of at least one portion other than the flexible display;
a deformation detection sensor that detects deformation of the electronic device in a state in which the touch is maintained;
a motion sensor that detects a motion of the electronic device within a predetermined time; and
a processor configured to cause an event to occur according to the motion.

12. The electronic device of claim 11, wherein the portion other than the flexible display comprises at least one of a circumferential edge and a rear surface of the electronic device.

13. The electronic device of claim 12, wherein the grip sensor is formed at a suitable location of the circumferential edge.

14. The electronic device of claim 13, wherein the grip sensor outputs a pressure change of the touch into an electrical signal.

15. The electronic device of claim 11, wherein the deformation comprises at least one of twisting, bending, and flexure of the electronic device.

16. The electronic device of claim 15, wherein the deformation detection sensor detects and outputs an electrical signal corresponding to a bending portion of the electronic device.

17. The electronic device of claim 16, wherein the deformation detection sensor is at least one of a tension sensor, a piezoelectric element, and a terrestrial magnetic sensor.

18. The electronic device of claim 11, wherein the motion sensor detects the motion with at least two sensors.

19. The electronic device of claim 18, wherein the motion sensor is at least one of an acceleration sensor, a gyro sensor, and a terrestrial magnetic sensor.

20. A method in an electronic device, the method comprising:
detecting a touch of at least one portion other than a flexible display of the electronic device;
detecting deformation and a motion of the electronic device within a predetermined time in a state in which the touch is maintained; and
causing an event to occur according to the deformation and motion.
